(19) United States
(12) Patent Application Publication
(10) Pub. No.: US 2015/0347952 A1
(43) Pub. Date: Dec. 3, 2015

(54) PARTNER ANALYTICS MANAGEMENT TOOL

(71) Applicant: Accenture Global Services Limited, Dublin (IE)

(72) Inventors: Lan Guan, Johns Creek, GA (US); Ramesh Venkataraman, Fairfax, VA (US)

(21) Appl. No.: 14/512,151

(22) Filed: Oct. 10, 2014

Related U.S. Application Data
(60) Provisional application No. 62/003,731, filed on May 28, 2014.

(51) Int. Cl. G06Q 10/06

(52) U.S. Cl. CPC G06Q 10/06393

(57) ABSTRACT

Systems and methods use a deterministic approach to identify, recruit and manage partners. According to some possible implementations, publicly and proprietary available data may be gathered, normalized and analyzed using proven statistical techniques to derive recruiting and ongoing partner performance.

### RELATED APPLICATIONS

This non-provisional application claims the benefit of the filing date under 35 U.S.C. §119(e) of Provisional U.S. Patent Application Ser. No. 62/003,731, filed May 28, 2014, which is hereby incorporated by reference in its entirety.

### BACKGROUND

1. Technical Field

The implementations discussed in the present application relate to computer systems for data analytics.

2. Background Information

Over the past few years, Original Equipment Manufacturers (OEMs) and service providers in the computing, telecom and networking equipment sectors have improved their ability to sell directly to customers or resellers, either online or through their own sales forces. The approach has worked well for selling to large customers in developed economies.

However, as OEMs and service providers look for growth in new markets, such as reaching customers in emerging economies, or selling to small and midsize businesses, they need to invest in processes and systems to enable and optimize the indirect sales channel, which involves sales done by business partners. At most companies, indirect/partner channel business does not get the same attention as direct sales done by the company itself. While most companies have made varying levels of investment in systems and processes to streamline the direct sales channel—for instance, through investments in Customer Relationship Management systems—the same cannot be said about the indirect/partner channel. As a result many organizations are not doing all they can to optimize this go-to-market strategy. A framework that assesses the entire partner management lifecycle for effectively managing channel partners can drive business growth.

As a result of lack of focus on business partners, OEMs and service providers may have a sub-optimal mix of partners in the partner program and that are not generating substantial revenues. The OEMs and service providers may further struggle to get partners trained and enable them to get “sales ready” quickly and may be unsure of improving the overall partner experience.

What is needed is a tool that allows for analysis of data, including partner analytical data, in a more efficient manner, more quickly, and with less computing or hardware resources. OEMs and service providers to focus on identifying and partnering with the most efficient and effective partners by scoring partners for strategic fit, and capturing partner performance metrics to use for partner management.

### BRIEF SUMMARY

Partner analytics and management systems, methods, and tools are provided to process and analyze partner analytics data, including profile data, market data, and performance data. Dimensions, attributes, and metrics related to partners are used to segment partners by applying and/or using statistical analysis, conversion algorithms, and metric-specific coefficients. The systems, methods, and tools described may be used to identify, recruit and manage partners and derive recruiting and partner performance.

According to some possible implementations, a device-implemented method may include compiling and storing data relating to a plurality of partners on a non-transitory computer readable memory and segmenting, using a computer processor, the plurality of partners into four segments based on the relative data of the plurality of partners, where the segmenting is organized according to portfolio quality and execution ability of the plurality of partners.

According to some possible implementations, a computer-readable medium may store one or more instructions that, when executed by one or more processors, cause the one or more processors to compile and store data relating to a plurality of partners on a non-transitory computer readable memory, and segment the plurality of partners into four segments based on the relative data of the plurality of partners, wherein the segmenting is organized according to portfolio quality and execution ability of the plurality of partners.

According to some possible implementations, a system may include a non-transitory computer readable memory storing data relating to a plurality of partners on, and a computer processor for segmenting the plurality of partners into four segments based on the relative data of the plurality of partners, wherein the segmenting is organized according to portfolio quality and execution ability of the plurality of partners.

### BRIEF DESCRIPTION OF THE DRAWINGS

FIG. 1 shows a diagram of an example implementation of a partner analytics and management system;

FIG. 2 shows a diagram of an example implementation of scoring partners for strategic fit;

FIG. 3 shows a diagram of an example partner segmentation framework;

FIG. 4 shows a diagram of an example segmentation approach;

FIG. 5 shows an example chart of metrics, attributes, and dimensions for the telecom industry;

FIG. 6 shows a diagram of an architecture overview of a partner analytics and management tool according to a possible implementation;

FIG. 7 shows a diagram of a detailed architectural overview of a partner analytics and management tool according to a possible implementation; and

FIG. 8 shows an example chart of metrics, attributes, dimensions, scoring guidelines, scores, and coefficients according to a possible implementation.

### DETAILED DESCRIPTION

The following detailed description of example implementations refers to the accompanying drawings. The same reference numbers in different drawings may identify the same or similar elements. The discussion that follows is exemplary in nature, rather than limiting. For example, although selected aspects, features, or components of implementations are depicted as stored in a program, data, or multipurpose system memories, all or part of systems and methods consistent with the partner analytic technology may be stored on or read from other machine-readable media, for example, secondary storage devices, such as hard disks or CD-ROMs, or other forms of machine readable media either currently known or later developed.

Furthermore, specific components of a partner analytics and management system are discussed herein, but methods, systems, and articles of manufactures consistent with the partner analytics and management technology may include additional or different components. For example, a processor may be implemented as a microprocessor, microcontroller, application specific integrated circuit (ASIC), discrete logic, or a combination of other types of circuits acting as explained above. Databases, tables, and other data structures may be separately stored and managed, incorporated into a single memory or data base, or generally logically and physically organized in many different ways. Programs, logic, or instructions executable by a processor, may be parts of a single program, separate programs, or distributed across several memories and processors.

A partner analytics and management system or tool may use a deterministic approach to identify, recruit and manage partners. As used herein, the term “partners” or “channel partners” may include, for example, value added resellers, retailers, distributors, vendors, consultants, system integrators, technology companies, service providers, or other entities that participate in an indirect sales channel of a user of the partner analytics and management system or tool, or a past, potential, existing, or future client or customer of a user of the partner analytics and management system or tool. Partners or channel partners may also include past partners, existing partners, potential partners, and/or future partners.

According to some possible implementations, publicly and proprietary available data may be gathered, normalized and analyzed using proven statistical techniques to derive recruiting and ongoing partner performance. The system may include multiple analytics modules employing proprietary analytics and visualization techniques and designs to provide an end-to-end comprehensive approach to improve partner recruiting effectiveness and onboarding efficiencies, and ultimately lift sales performance of partners for global telecommunications companies. The system may include a recruiting module that uses publicly and proprietary available data describing partner candidates' key performance attributes, and applies statistical-driven normalization and analytics techniques to derive and/or measure recruiting and ongoing partner performance. The system may include an onboarding module including reporting templates which allow users to view, update, track and report on information related to Sales Orientation, Sales Readiness and Sales Enablement. The system may include a Sales Performance module that allows users to view, track and analyze partners' pre- and post-sales performance using data analytics.

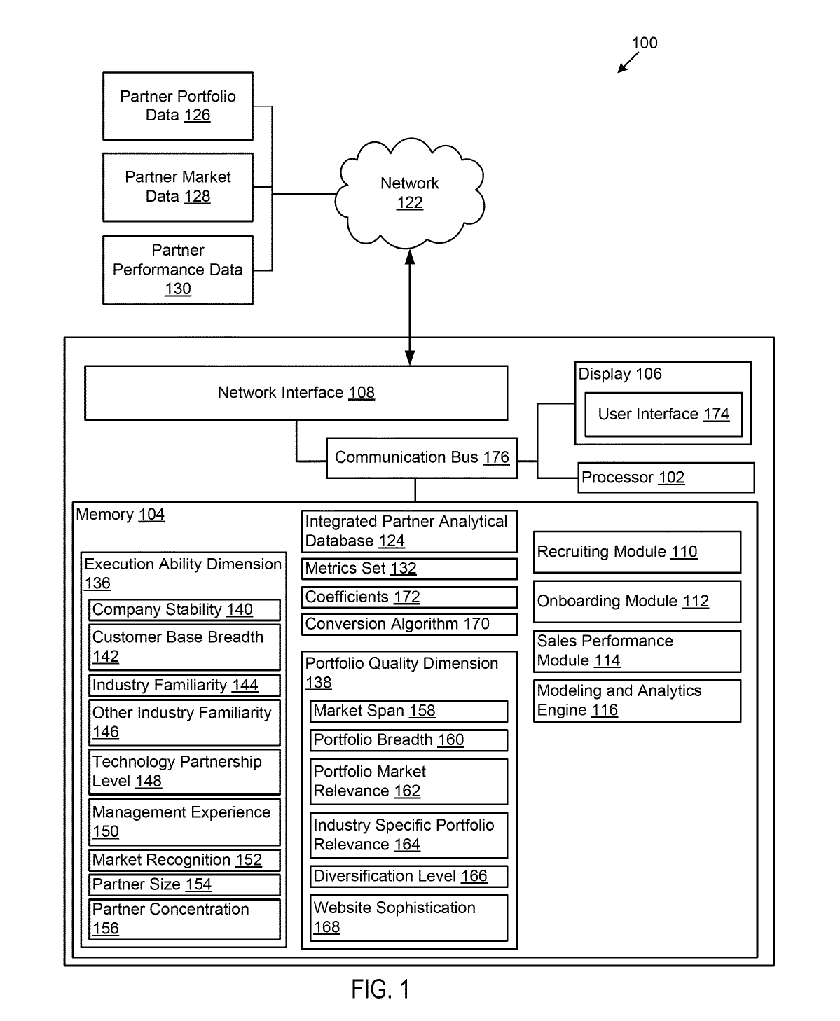

FIG. 1 shows a diagram of an example of a data processing system that may implement a partner analytics and management system. The partner analytics and management system 100 includes a processor 102, a memory 104, a display 106 and a network interface 108, connected via a communication bus 176. The memory 104 stores modules, data, databases, metrics, coefficients, and algorithms, and other data structures used or processed by the partner analytics and management system 100. For example, in some implementations, the memory 104 includes a partner recruiting module 110, a partner onboarding module 112, a partner sales performance module 114, and a modeling and analytics module 116, each of which includes logic or instructions executable by the processor 102 to perform partner analytics and management. The memory 104 includes one or more memories in communication with the processor 102. A data management module 120 receives data from external sources through the network interface 108 over a network 122 and compiles the data into an integrated partner analytical database 124. Integrated partner analytical records in the database 124 include information, such as geographic, region or location information and contact information for partners being evaluated or managed through the partner analytics and management system 100. External sources of data include partner profile data 126, partner market data 128 and partner performance data 130, or additional or other information and data relating to past, potential, existing and/or future partners.

The system 100 analyzes the partner profile data 126, partner market data 128 and partner performance data 130 to capture, derive, or calculate metrics related to, or indicative of, the partner execution ability 136 and metrics related to, or indicative of, the partner portfolio quality 138. The metrics for a particular partner may be captured in the integrated partner analytical record associated with that particular partner

In some implementations, the memory 104 also includes metrics 132 that measure, correspond to or link to attributes 134 that describe or relate to partners; and the attributes 136 in turn correspond or link to dimensions that describe or relate to partners. Metrics 132 describe or measure attributes using quantitative or qualitative values extracted or derived from the external sources of data, including partner portfolio data 126, partner market data 128 and partner performance data 130, or additional or other information and data relating to past, potential, existing and/or future partners. The dimensions include a partner execution ability dimension 136 and a partner portfolio quality dimension 138. The execution ability dimension 136 is measured by, calculated or determined from, or includes data describing key attributes of partners, such as company stability 140, customer base breadth 142, industry familiarity 142 (e.g., familiarity with a particular industry, such as telecom), other industry familiarity 144 (e.g., familiarity with other industries), technology partnership level 146, management experience 148, market recognition 150, partner size 152, and partner concentration 154. The portfolio quality dimension 156 is measured by, calculated or determined from, or includes data describing key attributes of partners, such as market span 158, portfolio breadth 160, portfolio market relevant 162, diversification level 164, and website sophistication 166. Some implementations of the system 100 may process different or additional dimensions, attributes and metrics for partner analytics and management.

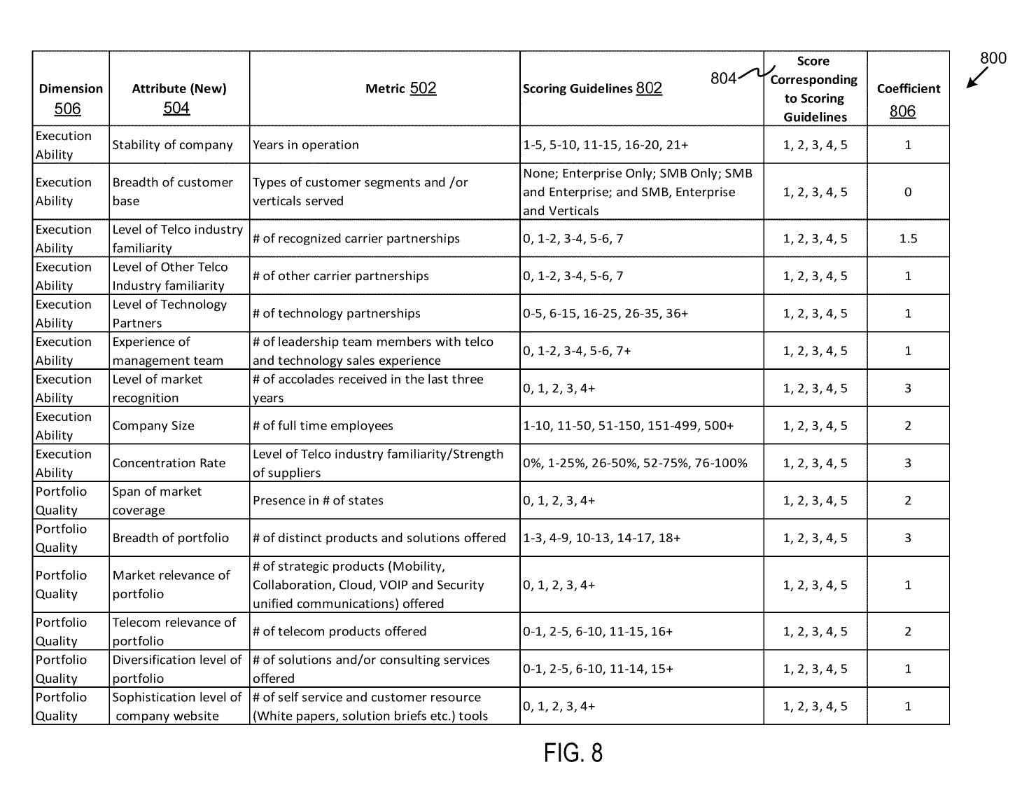

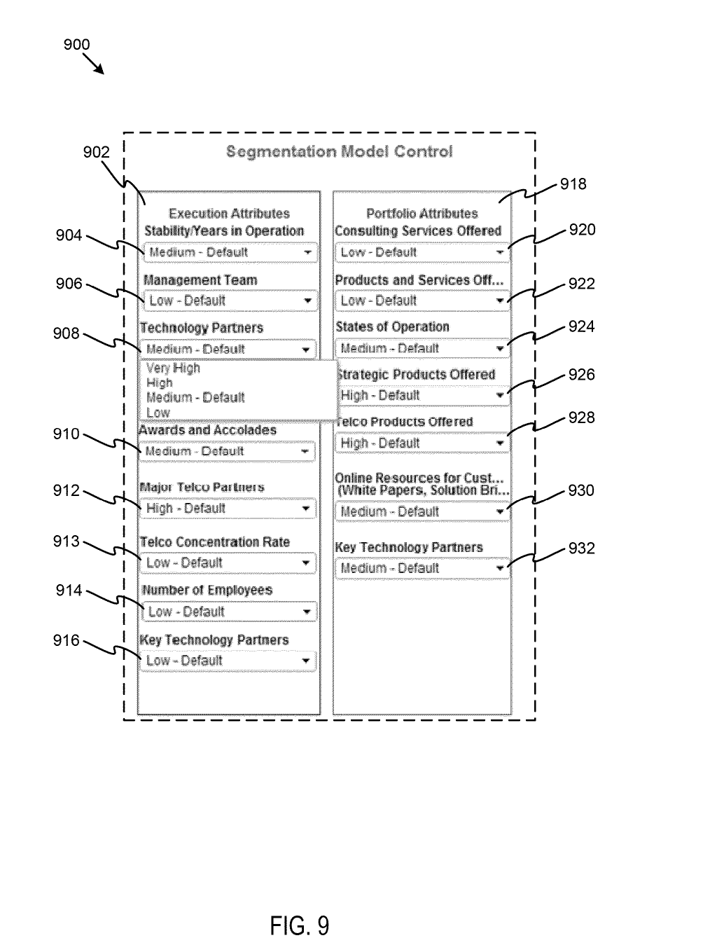

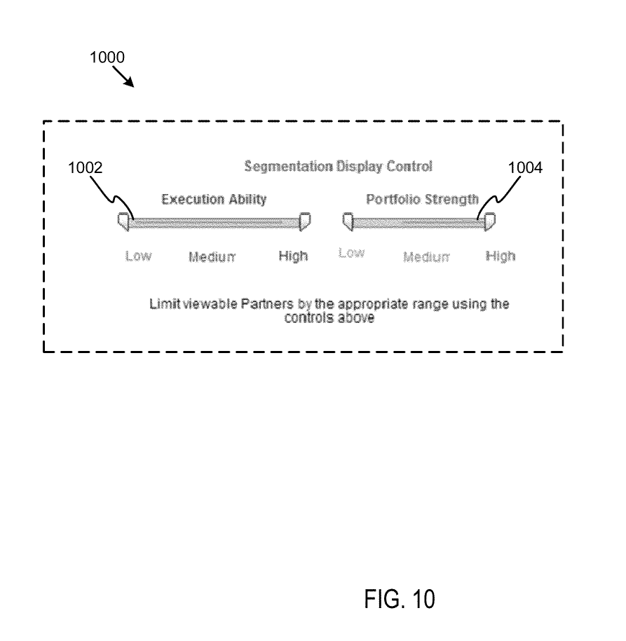

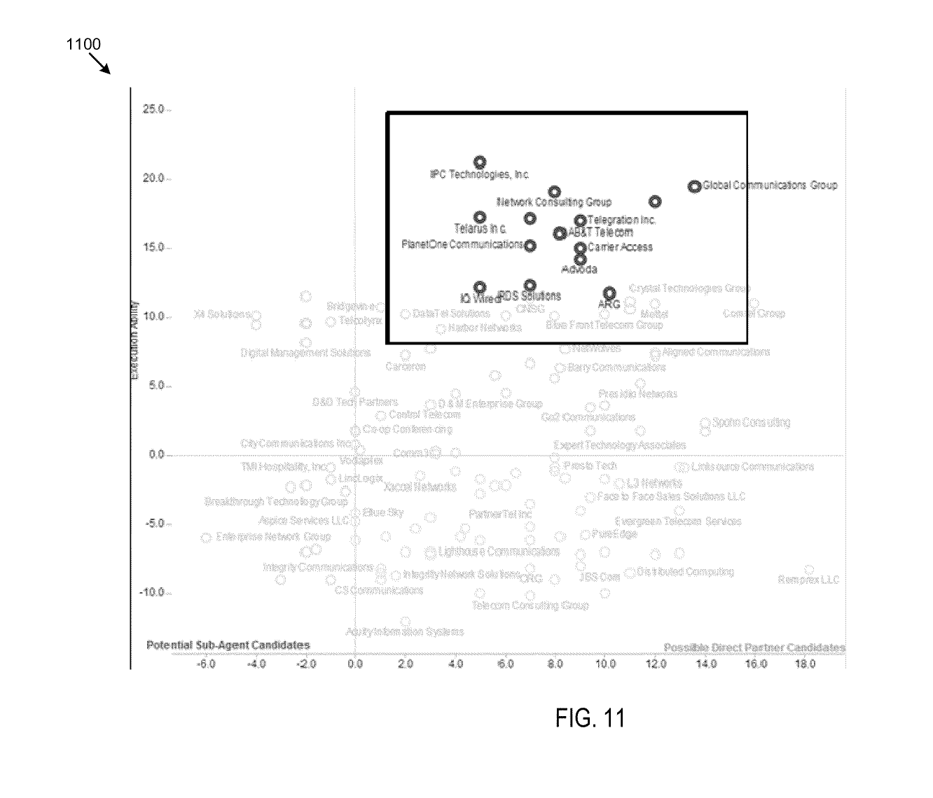

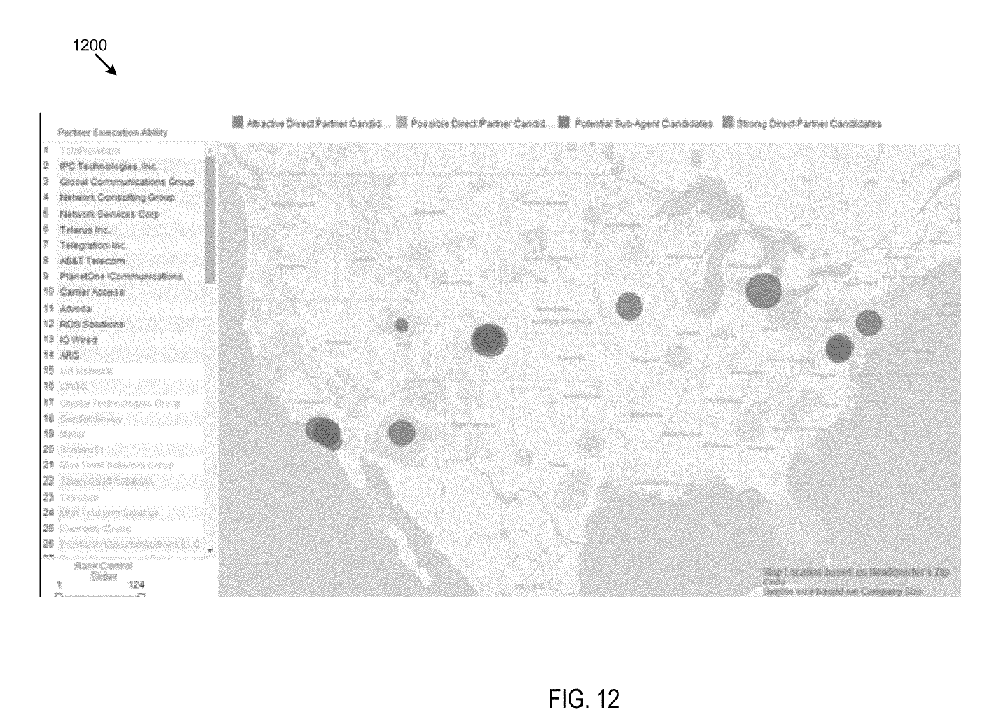

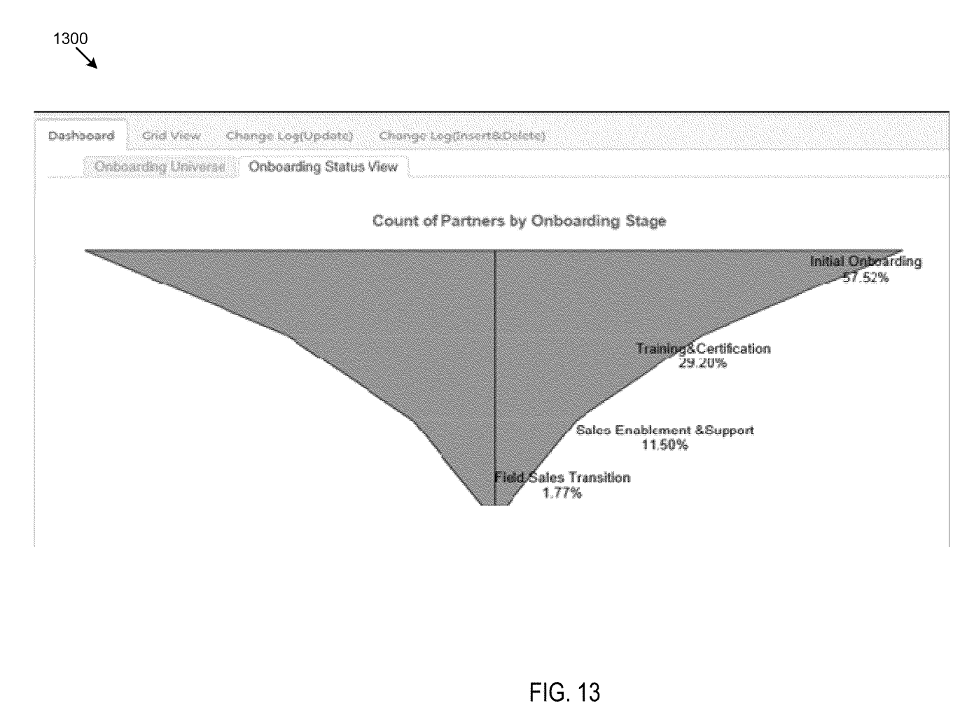

In some implementations, the system 100 receives the metrics 132, attributes 134 and dimensions 136 via the network interface from user input, data files, or data sources, including, for example, partner portfolio data 126, partner market data 128 and partner performance data 130, or additional or other information and data relating to past, potential, existing and/or future partners. The modeling and analytics engine 116 determines or calculates a score for each attribute of each dimension according to a conversion algorithm 170 stored in the memory 104. For example, the system 100 uses the conversion algorithm 170 to normalize, e.g., transfer or convert, all metrics 132 for all attributes to a common scale, such as a numeric scale (e.g., values ranging from 1 to 5) or a qualitative scale (e.g., high, medium, or low). An example of scoring guidelines for normalizing metrics 132 according to a conversion algorithm 170 is shown in FIG. 8, as discussed in further detail below. Alternatively or additionally, the conversion algorithm 170 is used to normalize, transfer or convert the metrics 132 to any number of scales particular, for example, to one or more groups of attributes and/or dimensions.

The modeling and analytics engine 116 applies metric-specific coefficients 172 to the metrics 132, for example, according to the significance of attributes associated with the metrics 132. For example, in some implementations, the modeling and analytics engine 116 may determine, using statistical methods and analyses, that the market recognition attribute 152 and the partner size attribute 154 have a stronger correlation to the execution ability dimension 136 than other attributes, such as, for example, the company stability attribute 140. Accordingly, the metric-specific coefficients may be greater for metrics associated with the market recognition attribute 152 and the partner size attribute 154, and lesser for metrics associate with the company stability attribute 140, thereby giving greater weight to the common scale or normalized score for the market recognition attribute 152 and the partner size attribute 154. As another example, the system 100 may determine that the market span attribute 158, portfolio breadth attribute 160 and industry specific portfolio relevance attribute 162 have a stronger correlation to the portfolio quality dimension 138 than other attributes, such as, for example, the website sophistication attribute 168. Thus, the metric-specific coefficients may be greater for the metrics associated with the market span attribute 158, portfolio breadth attribute 160 and industry specific portfolio relevance attribute 162, and lesser for the metrics associated with the website sophistication attribute 168.

Alternatively or additionally, the system 100 may determine, using statistical methods or analyses, that other attributes have a stronger or weaker correlation with the execution ability dimension 136 and the portfolio quality dimension 138. For example, the system 100 may perform statistical analyses on historical data to determine that one or more attributes correlate with higher execution ability dimension scores or higher portfolio quality dimension scores. In some implementations, the system 100 may receive the metric-specific coefficients from a user, and the metric-specific coefficients may be determined based on industry-specific experience and/or results from analyses and modeling performed by other systems or models. Other logic or instructions of the system 100, such as the recruiting module 110, onboarding module 112, and/or sales performance module 114 may be configured to apply the coefficients 172 to the metrics 132, and/or to perform part or all of any other operations or functions of the partner analytics, management and/or modeling.

In some implementations of the partner analytics system 100, a user interface 174 is provided to a user through the display 106. The system 100 may receive user input through the network 122. User input includes, for example, changes and/or initial value settings for metrics, 132, metric-specific coefficients 172, conversion algorithms 170, and/or dimensions, including, but not limited to, execution ability dimension 136 and portfolio quality dimension 138, and attributes linked to dimensions. The user interface 174 also receives, processes, and analyzes user input with the recruiting module 110, onboarding module 112, sales performance module 114, and modeling and analytics engine 116.

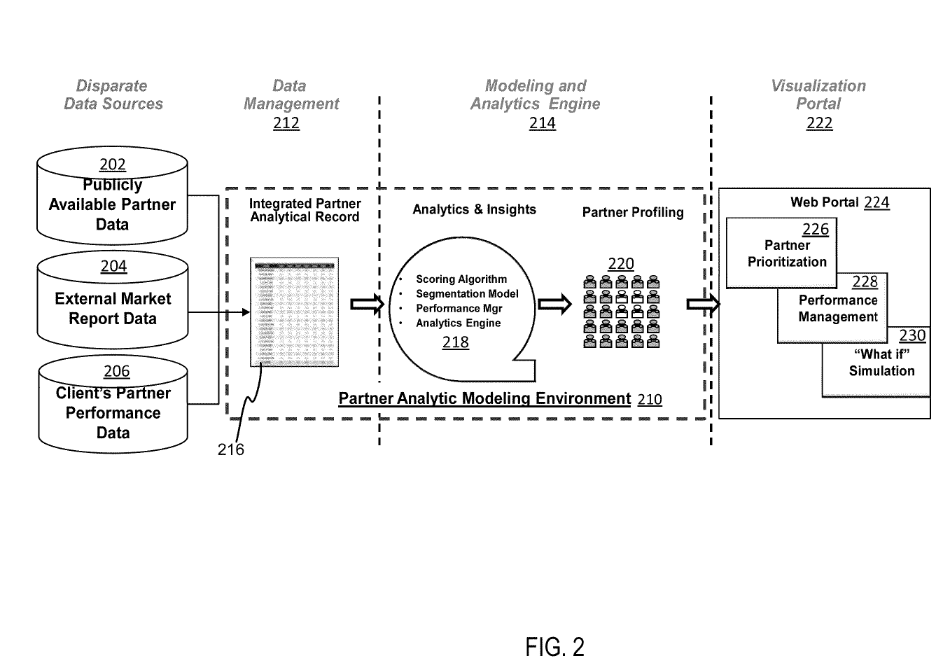

FIG. 2 shows a diagram of an implementation of a partner analytics and management system 200, or a system to score partners for strategic fit, and capture partner performance metrics to use for partner management and tuning (e.g., adjusting the metric-specific coefficients) of the scoring engine going forward. As shown in FIG. 2, data may be gathered from disparate data sources, which may include publicly available partner data or partner profile data 202, external partner market report data 204, and the client's partner performance data 206. A partner analytic modeling environment 210 may include data management engine 212 and a modeling and analytics engine 214. As part of the data management engine 212, the data may be compiled into an integrated partner analytical record 216. As part of a modeling and analytics engine step or process, analytics and insights 218 may be applied, for example, by using a scoring algorithm, a segmentation model, performance manager, and/or an analytics engine. As another part of the modeling and analytics engine 214 step or process, partner profiling 220 may be performed. Partner profiling 220 includes compiling data associated with a partner, including, for example, the data gathered from disparate resources. As part of a visualization portal 222 step or process, a web portal 224 may be used to implement partner prioritization 226, performance management 228, and a “what if” theoretical simulation 230 of cooperation with the various partners.

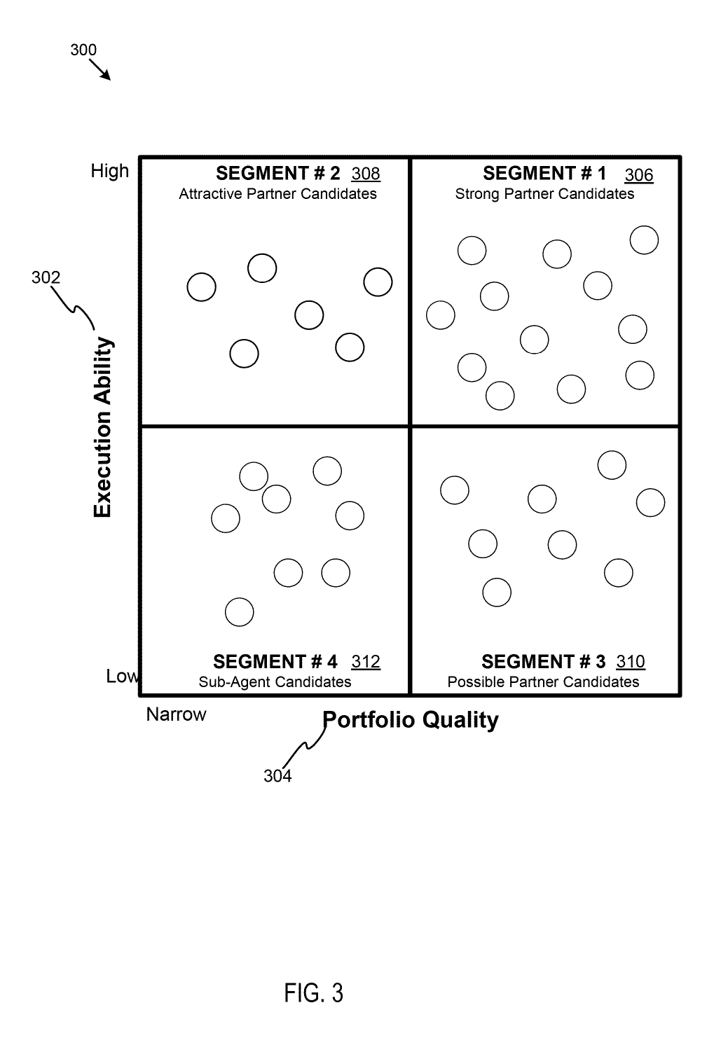

According to possible implementations, partners may be segmented into a Partner Segmentation Framework 300. An exemplary framework 300 is shown in FIG. 3. Partners may be evaluated according to execution ability 302 (low to high) and portfolio quality 304 (narrow to broad). Portfolio Quality 304 is defined as a gauge of breadth, depth and strategic alignment of partner's offerings. Execution Ability 302 is defined as an estimate of the partner's ability to achieve broad based success in the market place. Portfolio Quality 304 and Execution Ability 302 may be indicative of a partner's overall potential performance or actual performance, such as sales performance or service performance. For example, portfolio quality 304 may guage depth and strategic alignment of a partner's offerings against the client's strategic objectives; and execution ability 302 may estimate or measure the partner's trade record to achieve broad-based success in the market place using the partner's products and services. As shown in FIG. 3, partners are then placed into one of four prospect segment profiles or quadrants according to their execution ability and portfolio quality. The four prospect segment profiles or quadrants include:

Strong Direct Partner Candidates (Segment #1) 306: Experienced partners who have achieved tangible market success with a market relevant portfolio;

Attractive Direct Partner Candidates (Segment #2) 308: Market participants who have done well with the limited set of relevant offerings, and few key partnerships;

Possible Direct Partner Candidates (Segment #3) 310: Experienced partners, with limited relevant experience, who could potentially drive significant solution sales when combined with an attractive partner program offering; and

Potential Sub-Agent Candidates (Segment #4) 312: Relatively small market participant with limited or little exposure to relevant market and associated offerings.

In some implementations, the segments or quadrants are defined by a selected execution ability dimension score and a selected execution ability dimension score. The Strong Direct Partner Candidates (Segment #1) 306 captures or includes partners that have an execution ability dimension score that is greater than, or exceeds, the selected execution ability dimension score or threshold, and a portfolio quality dimension score that is greater than, or exceeds, the selected portfolio quality dimension score or threshold. The Attractive Direct Partner Candidates (Segment #2) 308 captures partners that have an execution ability dimension score that is greater than, or exceeds, the selected execution ability dimension score or threshold, and a portfolio quality dimension score that is below, or exceeded by, the selected portfolio quality dimension score or threshold. The Possible Direct Partner Candidates (Segment #3) 310 captures or includes partners that have an execution ability dimension score that is below, or exceeded by the selected execution ability dimension score or threshold, and a portfolio quality dimension score that is greater than, or exceeds, the selected portfolio quality dimension score or threshold. The Potential Sub-Agent Candidates (Segment #4) 312 captures or includes partners that have an execution ability dimension score that is below, or exceeded by the selected execution ability dimension score or threshold, and a portfolio quality dimension score that is below, or exceeded by, the selected portfolio quality dimension score or threshold.

According to some implementations, the selected execution ability dimension score and the selected portfolio ability dimension score are derived from or based on statistical analysis of historical data of past, present, or potential partners that identifies, for example, a threshold execution ability dimension score and a threshold portfolio quality score that correlates with partners who have achieved tangible market success with a market relevant portfolio. In some implementations, the selected execution ability score and the selected portfolio quality dimension scores may be determined or calculated as the average execution ability score and the average portfolio quality score of a selected group of past, existing, potential, or future partners. The system 100 may track onboarding progress and sales performance of existing and/or segmented partners, and verify accuracy of the partner analytics model (i.e., whether the model accurately predicts a partners that achieve a desirable or successful level of performance).

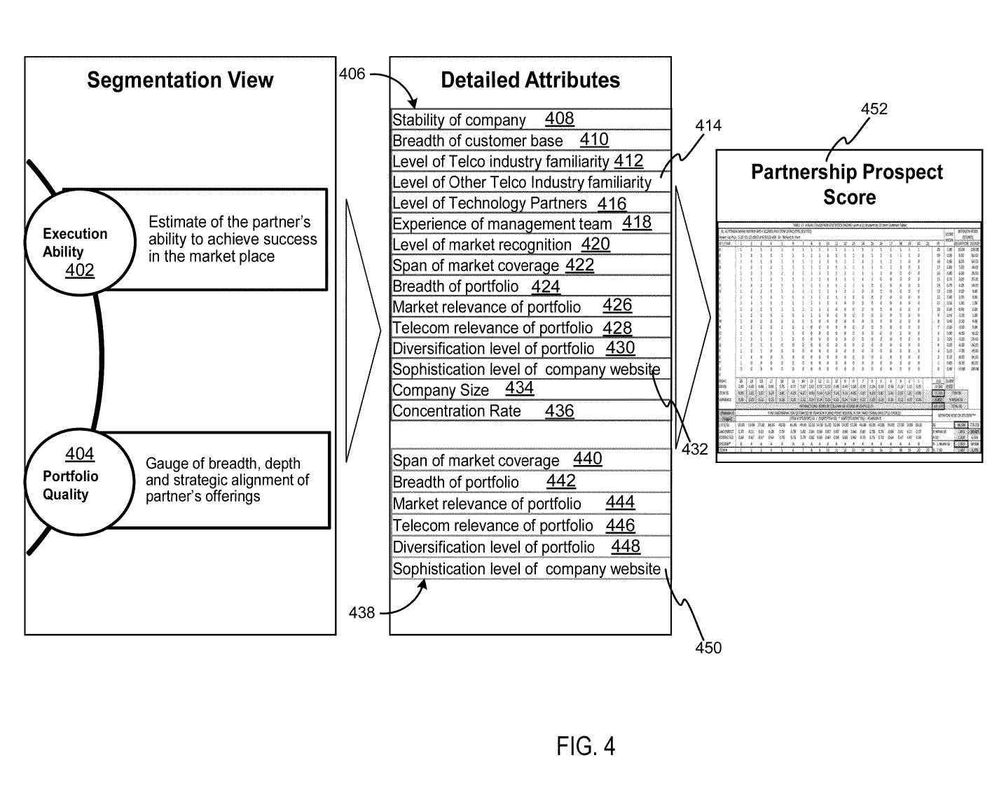

FIG. 4 shows a diagram of a segmentation approach or process 400 according to some implementations. As discussed above, partners may be segmented according to execution ability 402 and portfolio quality 404. In some implementations, execution ability 402 may be based on a number of detailed attributes 406, which may include one or more of the stability of the company 408, breadth of customer base 410, level of telco industry familiarity 412, level of other telco industry familiarity, 414 level of technology partners 416, experience of management team 418, level of market recognition 420, span of market coverage 422, breadth of portfolio 424, market relevance of portfolio 426, telecom relevance of portfolio 428, diversification level of portfolio 430, sophistication level of company website 432, company size 434, and concentration rate 436. In some implementations, portfolio quality 404 may be based on a number of detailed attributes 438, which may include one or more of the span of market coverage 440, breadth of portfolio 442, market relevance of portfolio 444, telecom relevance of portfolio 446, diversification level of portfolio 448, and sophistication level of company website 450. The detailed attributes 406, 438 may be used to calculate a partnership prospect score 452. Possible implementations may include using each of the detailed attributes listed above to calculate the execution ability and portfolio quality of the partners, or using various combinations of less than all of the detailed attributes, or additional or different detailed attributes, to calculate the execution ability 402 and portfolio quality 406.

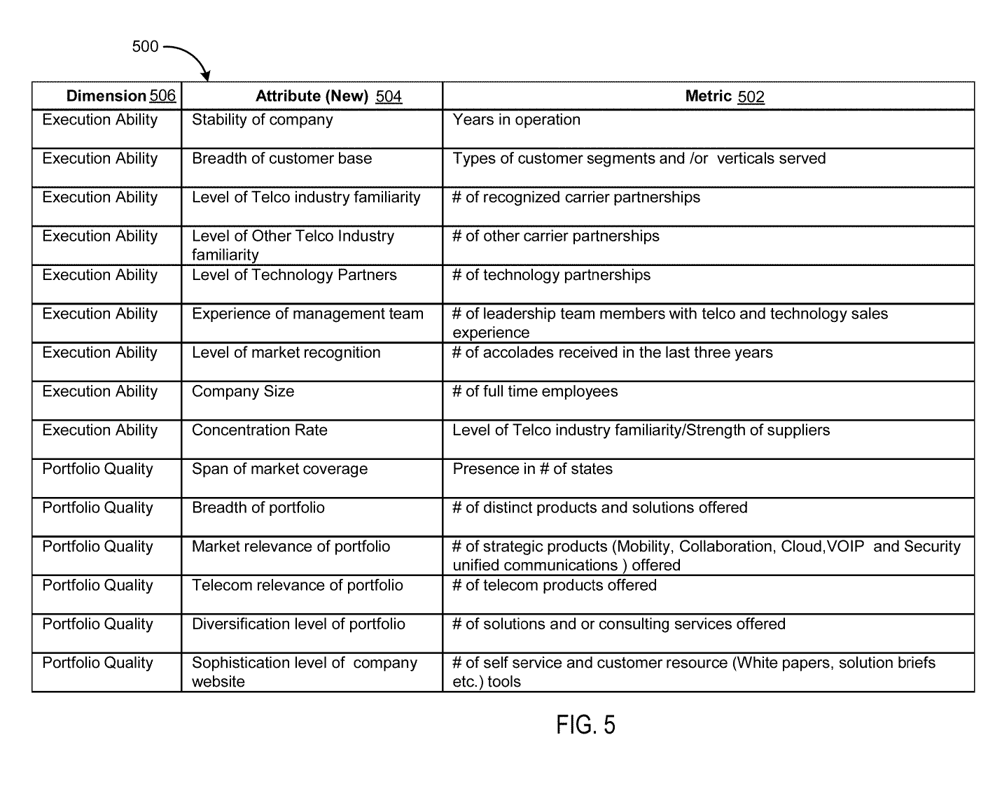

FIG. 5 shows an example chart of metrics 502 linked to attributes 504, which in turn are linked to the dimensions 506 for the telecom industry. For example, the metric for stability of the company may be years in operation; the metric for breadth of customer base may be types of customer segments (e.g., groups of customers sharing a similar trait or characteristic relevant to marketing) and/or verticals (e.g., markets in which goods and services offered are specific to an industry, trade, profession, or other group of customers with specialized needs) served; the metric for level of telco industry familiarity may be the number or count of recognized carrier partnerships (e.g., partnerships with major carriers, or with carriers that have a particular significance to the evaluating entity); the metric for level of other telco industry familiarity may be the number or count of other carrier partnerships (e.g., partnerships with smaller carriers, or with carriers who have less or no particular significance relative to the recognized carriers); the metric for level of technology partners may be the number or count of technology partnerships (e.g., the number of Original Equipment Manufacturers (OEM) or technology companies for which a candidate may be a channel partner); the metric for experience of management team may be the number or count of leadership team members with telco and technology sales experience; the metric for level of market recognition may be the number or count of accolades received in the last three years or other predetermined time period; the metric for company size may be the number or count of full time employees; the metric for concentration rate may be the level of telco industry familiarity/strength of suppliers (e.g., the extent of experience in the telecommunications industry and/or other types of technology partners with whom the suppliers have business interactions); the metric for span of market coverage may be the presence in the number of states; the metric for breadth of portfolio may be the number or count of distinct products and solutions offered; the metric for market relevance of portfolio may be the number of strategic products (e.g., products that are particularly significant to a strategic goal that may change over time, for example, Mobility, Collaboration, Cloud, VOIP and Security unified communications may have particular significance to telecom industry) offered; the metric for telecom or industry-specific relevance of portfolio may be the number or count of telecom or industry-specific products offered; the metric for diversification level of portfolio may be the number or count of solutions and or consulting services offered; and the metric for sophistication level of company website may be the number or count of self service and customer resource (White papers, solution briefs etc.) tools. Different or additional metrics may be used to measure, evaluate, manage or analyze partner prospect or performance and any related attributes and dimensions.

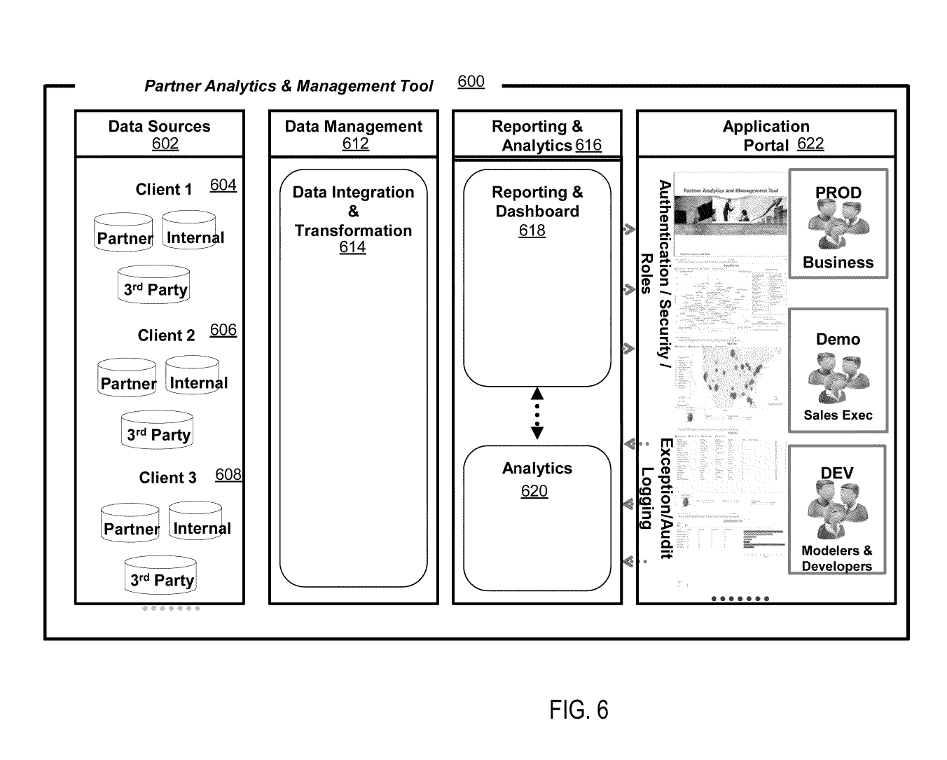

FIG. 6 shows a diagram of an architecture overview of a partner analytics and management tool 600 according to a possible implementation. The tool may include data sources 602 from various clients 604, 606, 608, data management 610, including data integration 612 and transformation 614, reporting and analytics 616, including reporting and dashboard 618 and analytics 620, and an application portal 622. The application portal 622 implements user authentication, security, and user roles. Exception and audit logging is also performed. The application portal 622 may be provided as a product to business clients, used by sales executives or other sales personnel in demonstrations, and/or used by modelers and developers.

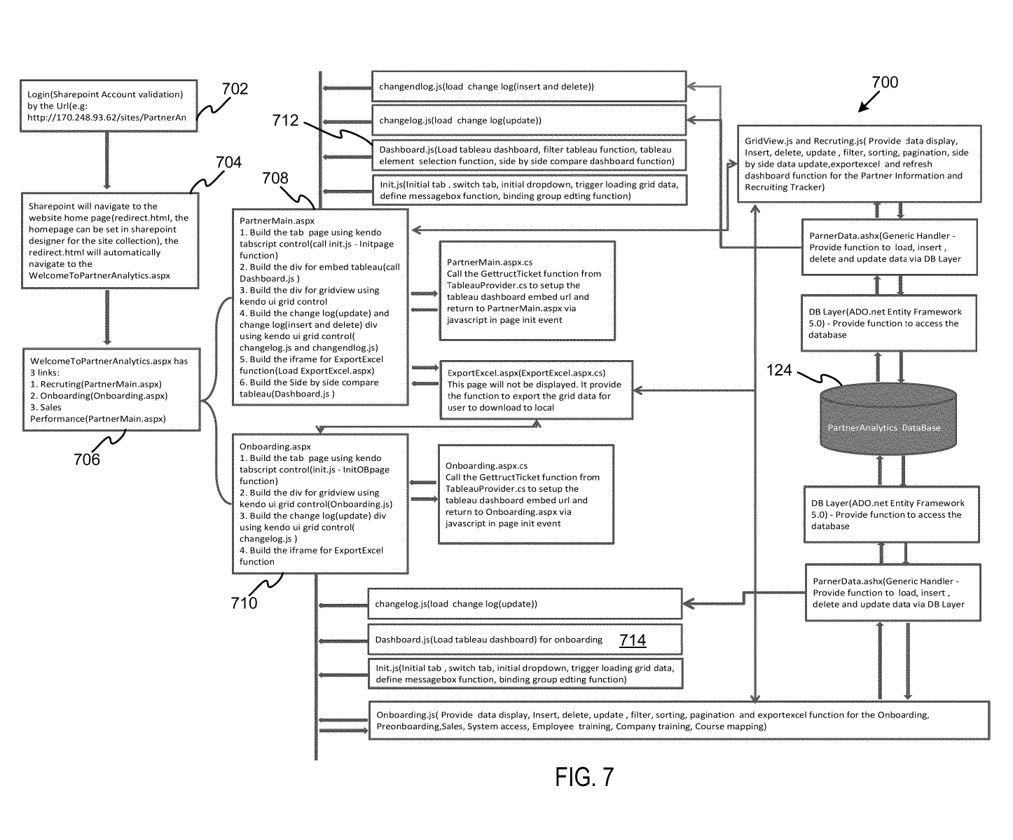

FIG. 7 shows a diagram of a detailed architectural overview of a partner analytics and management tool or system 700 according to a possible implementation. User inputted login information and/or credentials are received at step 702 through the user interface 174, which may be implemented, for example, through Microsoft SharePoint, or other program, now known or not yet existing. At step 704, upon verifying user credentials, the system 700 navigates to a welcoming screen or landing page that receives user input at step 706 to select or activate links to a recruiting module, an onboarding module, or a sales performance module. In some implementations, the sales performance module comprises a dashboard that displays key partner performance metrics. For example, the sales performance module may display aggregate program level metrics and individual partner level sales performance metrics. Sales performance data is captured and displayed across multiple dimensions, including, for example, product, region and time. Different or additional views may be presented to the user in other implementations of the system 100.

When the user selects or activates the link to the recruiting module, at step 708 the recruiting module receives user input via the user interface 174. The user input includes, for example, selection of a grid view of partner information, such as recruiting information; commands to import partner data from a data source, such as from a spreadsheet or database; and/or commands to analyze, display, and/or change recruiting information, such as activating the modeling and analytics engine to perform segmentation and generate a display of segmentation results. The user interface 174 may provide, at step 712 a summary or dashboard of recruiting status information, such as the stage in the recruiting process where each partner is at (e.g., identify and outreach, registration and application, validation and contracting). Companies have many partners to choose from, while partners have many different partner program enrollment options. The recruiting process provides both partners and companies a mechanism to determine the right match for the partner program under mutual consideration. When the user selects or activates the link to the onboarding module, at step 710, the onboarding module receives user input via the user interface 174. The user input includes, for example, selection of a grid view of partner information, such as onboarding information (e.g., onboarding status, contact, region/geographic, and/or segment information for each partner). At step 714, the user interface 174 may provide a summary or dashboard of onboarding status information, including a count of partners in each onboarding stage, onboarding effectiveness of partners by region, average days for partner completion of each onboarding stage. Onboarding stages may include initial onboarding, partner training and certification, sales enablement and support, and field sales transition. Different or additional recruiting stages and onboarding stages may be included in other implementations. The user interface 174 may further provide filters in any of the modules to allow the user to view partner information for selected groups of partners, e.g., by geographic location, company size, recruiting status, or other shared attribute, metric, or characteristic. Partner information, including recruiting and onboarding status, contact information, and location information may be stored and retrieved from partner analytics database, or integrated partner analytical database 124.

In some possible implementations, scoring guidelines or conversion algorithms 170 may be applied to each metric. The scoring guidelines or conversion algorithms 170 may be calculated, developed, or determined by analyzing the distribution of the values of the metrics for a number of partners and using a statistical method to normalize the distribution and choose the appropriate numerical or categorical ranges for each of the guidelines. Respective scores may then be matched to the scoring guideline ranges. For example, with regard to the attribute of stability of company, which corresponds to the metric of years in operation, the scoring guidelines or conversion algorithms 170 may include or determine that a first lowest range of years in operation that is scored as “1”, a second lowest range of years in operation that is scored as “2”, and so on up to a maximum number of years corresponding to a maximum score.

In some implementations, to calculate the execution ability value for a partner, the score for each attribute for execution ability is multiplied by a given respective coefficient, which reflects the importance of the particular attribute relative to the other attributes, and is then summed or aggregated to generate the execution ability value. Similarly, to calculate the portfolio quality, the score for each attribute for portfolio quality is multiplied by its respective coefficient, and is then summed or aggregated to generate the portfolio quality value. The execution ability and portfolio quality scores may then be used by the partner analytics system 100 to place the partner in the appropriate segment, as shown in FIG. 3.

In one implementation, the attributes of level of market recognition, breadth of portfolio, and concentration rate may have the highest coefficients. Span of market coverage, telecom relevance of portfolio, and company size may have the next highest coefficient. Level of telco industry familiarity may have the next highest coefficient. Stability of company, level of other telco industry familiarity, level of technology partners, experience of management team, market relevance of portfolio, diversification level of portfolio, and sophistication level of company may have the next highest coefficient. Breath of customer base may have the lowest coefficient.

If a score for a particular attribute is missing from the analysis of a particular partner, the missing score may be filled in using an average value of the score calculated using other partner scores. The average value of the score may then be multiplied by the respective coefficient and summed with the other attribute scores for either the execution ability or the portfolio coefficient.

FIG. 8 shows a chart 800 of the metrics 502, attributes 504, and dimensions 506 of FIG. 5, and also shows scoring guidelines 802 and the scores 804 corresponding to the scoring guidelines 802 for each of the attributes 504, according to a possible implementation. The metrics 502, attributes 504, and dimensions 506, scoring guidelines 802, the scores 804 corresponding to the scoring guidelines 802, and the metric-specific coefficients are variables and inputs for a partner analytics model. The scores 804 are indicative of the strength of a partner's ability to become a member of a partner program. Normalized scores may be normalized prior to being used as input to the partner analytics model. The scores 804 are matched, according to the conversion algorithms 170, to the scoring guidelines 802 as shown in FIG. 8. For example, with regard to the attribute of stability of company, which corresponds to the metric of years in operation, the score for 1-5 years in operation is “1”, the score for 6-10 years in operation is “2”, the score for 11-15 years in operation is “3”, the score for 16-20 years is “4”, and the score for 21+ years is “5”. The ranges that correspond to each score may be adjusted according to historical data, or data collected from applying the partner analytics model, including the metric-specific coefficients 806 and conversion algorithms 170, and tracking partner sales performance to determine whether the partner analytics model accurately reflects or predicts partner sales performance. Other scores are matched to their respective scoring guidelines for the other attributes as shown in FIG. 8.

In one implementation, to calculate the execution ability value or dimension score for a partner, the score for each attribute 504 for execution ability is multiplied by its respective coefficient 806, as shown in FIG. 8, and is then summed or aggregated to generate the execution ability value or dimension score. For example, with respect to the Telco industry familiarity attribute, which corresponds to the metric of number or count of recognized carrier partnerships, a partner that has partnerships with three recognized carriers would have a normalized score of “2.” To calculate the execution ability dimension score for the partner, its Telco industry familiarity score of “2” would be multiplied or weighted by the corresponding metric-specific coefficient of “1.5” to arrive at a weighted normalized value or score of “3.” A similar calculation is applied for each of the attributes, and the weighted normalized scores for all attributes relevant to a dimension are aggregated to determine the dimension score. The conversion algorithms 170 may also include qualitative conditions. For example, the metric for the customer base breadth attribute is the types of customer segments and/or verticals served. A partner that serves SMB and Enterprise customers would have a score of 4. As shown in FIG. 8, the corresponding metric-specific coefficient is “0,” which indicates that the system 100 determines no weight to be given to the customer base breadth attribute since the weighted normalized score would also be “0.” In other implementations, the conversion algorithms 170 may include different or additional scores for different or additional metric values or scoring guidelines than those shown in FIG. 8.

Similarly, to calculate the portfolio quality, the score for each attribute for portfolio quality is multiplied by its respective coefficient, and shown in FIG. 8, and is then summed or aggregated to generate the portfolio quality value. Benefits of the possible implementations of systems and methods described herein may include one or more of: an improved mix and quality of partners, reduced recruiting cycle time, a shorter window to getting the first sale from a partner, faster sales ramp-up for partners, lower volume of onboarding and mobilization questions, fewer dedicated personnel required to support the channel, higher revenue streams from a higher quality and mix of partners, greater penetration into mid-tier markets and new logo acquisitions, increased visibility into partner performance and better decision making, improved leverage of indirect channels resulting in lower overall sales costs, increased sales productivity, and better indirect channel partner experience.

FIG. 9 shows an example of an implementation of a segmentation model control 900 of a user interface 174 to receive user input through drop down menus or filters to control partner segmentation, modeling and analysis, and a graphical display of the same. The user input may include a selection from filters for execution attributes 902, including stability/years in operation 904, management team 906, technology partners 908, awards and accolades 910, major telco partners 912, number of employees 914, and key technology partners 916. The user input may also include a selection from filters for portfolio attributes 918, including consulting services offered 920, products and services offered 922, states of operation 924, strategic products offered 926, telco products offered 928, online resources for customers 930, and key technology partners 932. The filters receive user input of a selection of a value, such as “very high,” “high,” “medium,” or low, that correspond to metric ranges or values for each of the attributes; and in response to the user input, the partner analytics and management system 100 performs, changes, and updates partner analytics and segmentation according to the filter values received from the user.

According to some implementations, as shown in FIG. 10, a segmentation display control 1000 is provided to the user via the user interface 174. User input received is through the segmentation control 1000 and includes a selection of groups of partners to view in a segmentation view and/or a graphical representation view of the user interface. For example, the user may use sliding controls 1002 and 1004 to display partners with an execution ability score and a portfolio strength score within one or more of a low, medium or high range. Alternatively or additionally, other types of controls, such as numerical fields, check boxes, or radio buttons. FIG. 11 is an example of a segmentation view 1100 of the user interface 174, highlighting partners with metrics that score or fall within selected values received as user input through the segmentation display control 1000. In a geographic view 1200, as shown in FIG. 12, the user interface 174 may provide a geographical representation of locations of partners with metrics that score or fall within selected values for each attribute. Different or additional attributes and filter values may be presented.

In some implementations, the user interface 174 includes a graphical representation or view 1300 of onboarding status information. For example, a count or percentage of partners in various onboarding stages may be provided as shown in FIG. 13. In some implementations, onboarding enables channel partners to learn or become fully aware of the product or service and any supporting systems to start selling independently. Intermediate milestones in the onboarding process are tracked and measured to ensure that the channel partner is making progress to becoming “sales ready.” Onboarding milestones, or stages, may include initial onboarding, partner training and certification, sales enablement and support, and field sales transition. Different or additional onboarding stages may be included in other implementations.

According to some implementations of the partner analytics and management tool described herein, partner analytical data, including execution ability and portfolio quality dimensions, corresponding attributes and metrics, and metric-specific coefficients, may be processed more efficiently, more quickly, and using less computing or hardware resources.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

1. A partner analytics system comprising:
a network interface;
a memory coupled with the network interface, the memory having stored thereon partner analytics logic and an integrated partner analytics database comprising partner profile data, partner market data, and partner performance data for a plurality of partners;
a processor in communication with the memory and the network interface, the processor configured to execute the partner analytics logic comprising instructions that when executed causes the processor to:
generate, using the processor, integrated partner analytical records for the plurality of partners by analyzing the partner profile data, the partner market data, and the partner performance data to capture metrics for a partner execution ability dimension and metrics for a partner portfolio quality dimension;
store, on the memory, the integrated analytical records for the plurality of partners;
normalize, using the processor, the metrics for the partner execution ability dimension and the metrics for the partner portfolio quality dimension to a common scale according to a set of predetermined conversion algorithms;
weight, using the processor, the metrics for the partner execution ability dimension and the metrics for the partner portfolio quality dimension according to predetermined metric-specific coefficients;
calculate, from the weighted normalized metrics for the partner execution ability dimension, a partner execution ability dimension score for each of the plurality of partners;
calculate, from the weighted normalized metrics for the partner portfolio quality dimension, a partner quality portfolio dimension score for each of the plurality of partners; and
segment, using the processor, the plurality of partners into four segments defined by a selected value for the partner execution ability dimension and a selected value for the partner portfolio quality dimension.

2. The system of claim 1, wherein the metrics indicative of the partner execution ability dimension comprise:
a count of accolades received within a predetermined period of time, the count of accolades indicative of a market recognition attribute for a partner of the plurality of partners; and
a count of employees occupied by the partner, the count of employees indicative of a partner size attribute for the partner of the plurality of partners.

3. The system of claim 1, wherein the metrics indicative of the portfolio quality dimension comprise:
a count of geographic locations where a partner of the plurality of partners is present, the count of geographic locations indicative of a market span attribute of the partner of the plurality of partners;
a count of distinct products and solutions indicative of a portfolio breadth attribute of the partner of the plurality of partners; and
a count of industry specific products indicative of a portfolio relevance attribute of the partner of the plurality of partners.

4. The system of claim 1, wherein partner analytics logic further comprises instructions to:
calculate the partner execution ability dimension score for each partner by summing the weighted normalized metrics indicative of the execution ability dimension; and
calculate the portfolio quality dimension score for each partner by summing the weighted normalized metrics indicative of the portfolio quality dimension.

5. The system of claim 1, wherein the partner analytics logic further comprises instructions to:
calculate the selected value for the partner execution ability dimension as an average of the partner execution ability dimension scores for the plurality of partners; and
calculate the selected value for the partner execution ability dimension as an average of the partner portfolio quality scores for the plurality of partners.

6. The system of claim 1, wherein the partner analytics logic further comprises instructions to:
define a first segment to capture partners having execution ability dimension scores greater than the selected value for the execution dimension and having portfolio quality dimension scores greater than the selected value for the portfolio quality dimension;
define a second segment to capture partners having execution ability dimension greater than the selected value for the execution dimension and having portfolio quality dimension scores less than the selected value for the portfolio quality dimension;
define a third segment to capture partners having execution ability dimension scores less than the selected value for the execution dimension and having portfolio quality dimension scores greater than the selected value for the portfolio quality dimension; and
define a fourth segment to capture partners having execution dimension scores less than the selected execution ability dimension and having portfolio quality dimension scores less than the selected value for the portfolio quality dimension.

7. The system of claim 6, wherein the partner analytics logic further comprises instructions to:
identify the partners captured in the first segment as strong partner candidates;
identify the partners captured in the second segment as attractive partner candidates;
identify the partners captured in the third segment as possible partner candidates; and
identify the partners captured in the fourth segment as potential sub-agent candidates.

8. The system of claim 1, wherein the partner analytics logic further comprises instructions to:
generate, on a display in communication with the processor, a graphical representation of the segmentation of the plurality of partners.

9. The system of claim 1, wherein the partner analytics logic further comprises instructions to:
receive, via a user interface in communication with the processor, a user selected range of execution ability dimension values and a user selected range of portfolio quality values;
determining a subset of the plurality of partners by selecting the partners having execution ability dimension scores that fall within the user selected range of execution ability dimension values, and having portfolio quality dimension scores that fall within the user selected range of portfolio quality values; and
generate, on a display in communication with the processor, a graphical representation of the selected subset of the plurality of partners, wherein the graphical representation comprises a virtual map of locations of partners in the selected subset.

10. The system of claim 1, wherein the predetermined metric-specific coefficients are determined based on historical data of the plurality of partners.

11. A partner analytics system comprising:
a computer processor in communication with a memory, the memory comprising:
a partner universe database including integrated partner analytical records for a plurality of partners; and
partner analytic logic that when executed by the processor causes the processor to:
receive from an external database, via a network interface, partner profile data, partner market data, and partner performance data;
generate the integrated partner analytical records for a plurality of partners by analyzing the partner profile data, the partner market data, and the partner performance data to capture metrics indicative of market recognition attributes, metrics indicative of market span attributes, metrics indicative of portfolio breadth attributes, metrics indicative of industry specific portfolio relevance attributes, and metrics indicative of partner size attributes for the plurality of partners;
normalize the metrics indicative of market recognition attributes, the metrics indicative of market span attributes, the metrics indicative of the portfolio breadth attributes, the metrics indicative of the industry specific portfolio relevance attributes, and the metrics indicative of the partner size attributes to a common scale according to predetermined conversion algorithms;
create an execution ability dimension for each partner of the plurality of partners by:
applying predetermined attribute-specific coefficients to metrics indicative of the market recognition attributes and metrics indicative of the partner size attributes to generate a market recognition score and a partner size score for each partner, and
aggregating the market recognition score and the partner size score to generate the execution ability dimension;
create a portfolio quality dimension for each partner of the plurality of partners by:
applying the predetermined attribute-specific coefficients to the metrics indicative of the market span attributes, the metrics indicative of portfolio breadth attributes, and the metrics indicative of the industry specific portfolio relevance attributes to generate a market span score, a portfolio breadth score, and an industry-specific portfolio relevance score;
aggregating the market span score, the portfolio breadth score, and the industry-specific portfolio relevance score to generate the portfolio quality dimension;
segment the plurality of partners into quadrants according to the execution ability dimension and portfolio quality dimension of each partner of the plurality of partners, wherein the segments are defined by a selected value for the execution ability dimension and a selected value for the portfolio quality dimension; and
generate, on a display in communication with the processor, a graphical representation of the segmentation of the plurality of partners.

12. The system of claim 11, wherein the partner analytic logic, when executed by the processor, further causes the processor to:
calculate the selected value for the execution ability dimension as an average execution dimension score for the plurality of partners based on the execution ability dimension for each partner of the plurality of partners; and
calculate the selected value for the execution ability dimension as an average portfolio quality dimension score for the plurality of partners based on the portfolio quality dimension for each partner of the plurality of partners.

13. The system of claim 11, wherein the partner analytic logic, when executed by the processor, further causes the processor to:
receive, via the network interface, a user input comprising a predetermined execution ability dimension score and a predetermined portfolio quality dimension score; and
segment the plurality of partners by using the predetermined execution ability dimension score as the selected value for the execution dimension and by using the predetermined portfolio quality dimension score as the selected value for the portfolio quality dimension.

14. The system of claim 11, wherein the partner analytic logic, when executed by the processor, further causes the processor to:
segment a partner of the plurality of partners into a strong direct partner quadrant when the execution ability dimension of the partner is greater than the selected execution dimension score and the portfolio quality dimension is greater than the selected portfolio quality dimension score;
segment the partner of the plurality of partners into an attractive direct partner quadrant when the execution ability dimension of the partner is greater than the selected execution dimension score and the selected portfolio quality dimension score is greater than the portfolio quality dimension of the partner;
segment the partner of the plurality of partners into a possible direct partner quadrant when the selected execution ability dimension score is greater than the execution ability dimension of the partner and the portfolio quality dimension of the partner is greater than the selected portfolio quality dimension score; and
segment the partner of the plurality of partners into a potential sub-agent direct partner quadrant when the selected execution dimension score is greater than the execution ability dimension of the partner and the selected portfolio quality dimension score is greater than the portfolio quality dimension of the partner.

15. The system of claim 11, wherein:
the metrics indicative of the market recognition attributes comprise a count of accolades received by a partner of the plurality of partners; and
the metrics indicative of the partner size attributes comprise a count of employees of the partner of the plurality of partners.

16. The system of claim 11, wherein:
the metrics indicative of the market span attributes comprise a count of geographic locations where a partner of the plurality of partners is present;
the metrics indicative of portfolio breadth attributes comprise a count of distinct products offered by the partner of the plurality of partners; and
the metrics indicative of the industry specific portfolio relevance attributes comprise a count of industry specific products offered by the partner of the plurality of partners.

17. The system of claim 11, further comprising:
a display in communication with the processor; wherein the partner analytic logic, when executed by the processor, further causes the processor to:
determine a selected subset of the plurality of partners by selecting the partners having execution ability dimension scores that fall within a user selected range of execution ability dimension scores, and having portfolio quality dimension scores that fall within a user selected range of portfolio quality scores; and
generate, on the display via a user interface, a graphical representation of a graphical representation of a selected subset of the plurality of partners, wherein the graphical representation comprises a virtual map of locations of partners in the selected subset.

18. The system of claim 11, wherein the predetermined metric-specific coefficients are determined based on historical data of the plurality of partners.

19. A method for partner analytics, the method comprising:
receiving from an external database, via a network interface, partner profile data, partner market data, and partner performance data;
generating, by a processor in communication with the network interface, an integrated partner analytical record for a plurality of partners by analyzing the partner profile data, the partner market data, and the partner performance data to capture metrics indicative of a partner execution ability dimension and metrics indicative of a partner portfolio quality dimension;
normalizing, by a modeling and analytics engine with the processor, the metrics indicative of a partner execution ability dimension and the metrics indicative of a partner portfolio quality dimension to a common scale according to predetermined conversion algorithms;
weighting, by the modeling and analytics engine with the processor, the indicative of a partner execution ability dimension and the metrics indicative of a partner portfolio quality dimension according to predetermined metric-specific coefficients; and
segmenting, by the modeling and analytics engine with the processor, the plurality of partners into four segments defined by the partner execution ability dimension and the partner portfolio quality dimension

20. A method for partner analytics, the method comprising:
receiving from an external database, via a network interface, partner profile data, partner market data, and partner performance data;
generating, by a processor in communication with the network interface, an integrated partner analytical record for a plurality of partners by analyzing the partner profile data, the partner market data, and the partner performance data to capture metrics for market recognition attributes, metrics for market span attributes, portfolio breadth attributes, metrics for industry specific portfolio relevance attributes, and metrics for partner size attributes for the plurality of partners;
storing the integrated partner analytical record in a memory in communication with the processor;
normalizing, by a modeling and analytics engine with the processor, the metrics for market recognition attributes, the metrics for market span attributes, the metrics for portfolio breadth attributes, the metrics for industry specific portfolio relevance attributes, and the metrics for partner size attributes to a common scale according to predetermined conversion algorithms;
calculating, by the modeling and analytics engine with the processor, an execution ability dimension for each partner of the plurality of partners by:
applying predetermined attribute-specific coefficients to the metrics for market recognition attributes and the metrics for partner size attributes to generate a market score and a partner size score for each partner, and
aggregating the market recognition score and the partner size score to generate the execution ability dimension;
calculating, by modeling and analytics engine with the processor, a portfolio quality dimension for each partner of the plurality of partners by:
applying the predetermined attribute-specific coefficients to the metrics for market span attributes, the metrics for portfolio breadth attributes, and the metrics for industry specific portfolio relevance attributes to generate a market span score, a portfolio breadth score, and an industry-specific portfolio relevance score;
aggregating the market span score, the portfolio breadth score, and the industry-specific portfolio relevance score to generate the portfolio quality dimension; and
segmenting, by the modeling and analytics engine with the processor, the plurality of partners into a strong direct partner segment, an attractive direct partner segment, a possible direct partner segment, and a potential sub-agent segment, wherein the segmenting is based on a selected value for the execution dimension and a selected value for the portfolio quality dimension for each partner of the plurality of partners.
